(19) United States
(12) Patent Application Publication
(10) Pub. No.: US 2010/0205338 A1
(43) Pub. Date: Aug. 12, 2010

(54) Network connection system

(75) Inventor: Bang Joon Byun, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon (KR)

(21) Appl. No.: 12/656,094

(22) Filed: Jan. 15, 2010

(30) Foreign Application Priority Data
Feb. 12, 2009 (KR) 10-2009-11404

(51) Int. Cl. G06F 13/42

(52) U.S. Cl. 710/106

(57) ABSTRACT

A network connection system including a Universal Serial Bus (USB) input/output server device to connect a Personal Computer (PC) terminal or different networks to a plurality of Ethernet/Internet protocol (IP) communication networks is described. The network connection system includes a USB input/output server device connected to a plurality of Ethernet/IP communication networks, and a PC terminal connected to a USB port of the USB input/output server device so as to be connected to the networks. Accordingly, the PC terminal may be connected to the Ethernet/IP communication networks without using a separate network interface card (NIC) in order to communicate.

### CROSS-REFERENCE TO RELATED APPLICATIONS

This application claims the benefit of Korean Patent Application No. 2009-0011404, filed on Feb. 12, 2009 in the Korean Intellectual Property Office, the disclosure of which is incorporated herein by reference.

### BACKGROUND

1. Field

One or more embodiments of the present disclosure relate to a network connection system to connect a plurality of Ethernet/Internet protocol (IP) communication networks.

2. Description of the Related Art

Generally, Ethernet/Internet protocol (IP) is an open type industrial standard extended from traditional Ethernet using an industrial protocol, and is mainly used for real-time control applications. This standard was first introduced in 2001, and may be the most developed industrial Ethernet network solution available for factory automation.

Ethernet/IP is one network standard to execute a Common Industrial Protocol (CIP) of an upper layer, and is a stand-alone type media protocol supported by several hundred vendors worldwide. In addition, Ethernet/IP uses a Transmission Control Protocol (TCP)/User Datagram Protocol (UDP)/IP, which is available even on the general Internet, with respect to all functions associated with automation, such as configuration, information management, I/O control, time synchronization, safety management, motion control or the like.

Meanwhile, Ethernet/IP facilitates the use of the newest network technologies using CIP such as a DeviceNet network, a ControlNet network or a CompoNet network. It is expected that in the future the use of Ethernet/IP will continue to increase in many industrial fields to enhance factory automation.

### SUMMARY

Therefore, it is an aspect of the present disclosure to provide a network connection system including a Universal Serial Bus (USB) input/output server device to connect a Personal Computer (PC) terminal or different networks to a plurality of Ethernet/Internet protocol (IP) communication networks.

Additional aspects of the disclosure will be set forth in part in the description which follows and, in part, will be obvious from the description, or may be learned by practice of the disclosure.

In accordance with one aspect of the present disclosure, there is provided a network connection system including: a Universal Serial Bus (USB) input/output server device connected to a plurality of Ethernet/IP communication networks; and a Personal Computer (PC) terminal connected to a USB port of the USB input/output server device so as to be connected to the networks.

The USB input/output server device may include a USB driver to receive data from the PC terminal.

The USB driver may receive data in real time by a USB communication protocol.

The USB input/output server device may include a buffer to prepare for the conversion of the data into data necessary for Ethernet/IP communication.

The USB input/output server device may include an analyzer to analyze the data prepared to be converted to data in a format necessary for Ethernet/IP communication.

The USB input/output server device may include an Ethernet/IP driver to convert the data into data suitable for an Ethernet/IP communication protocol such that communication is performed between the PC terminal and the networks according to an Ethernet/IP communication protocol scheme.

The USB input/output server device may include a transmission switch to transmit data to a consumer on the networks.

The PC terminal may include a USB driver to transmit data to the USB input/output server device.

The PC terminal may further include an application to perform data communication with the USB driver.

In accordance with another aspect of the present disclosure, there is provided a network connection system including: an Ethernet/Internet protocol (IP) switch connected to a plurality of Ethernet/IP communication networks; and a Universal Serial Bus (USB) input/output server device connected to the Ethernet/IP switch and further connected to one or more Ethernet/IP communication networks.

The Ethernet/IP switch may be connected to the plurality of networks by Ethernet lines.

The USB input/output server device may be connected to the Ethernet/IP switch by USB lines, and is further connected to different networks.

The USB input/output server device may include a USB port, and the network connection system may further include a personal computer (PC) terminal connected to the USB port so as to be connected to the networks.

The USB input/output server device may include a USB driver to receive data from the PC terminal.

The USB driver may receive data in real time according to a USB communication protocol.

The USB input/output server device may include a buffer to prepare for conversion of the data into data necessary for Ethernet/IP communication.

The USB input/output server device may include an analyzer to analyze the data prepared to be converted to data in a format necessary for Ethernet/IP communication.

The USB input/output server device may include an Ethernet/IP driver to convert the data into data suitable for an Ethernet/IP communication protocol such that communication is performed between the PC terminal and the networks according to an Ethernet/IP communication protocol scheme.

The PC terminal may include a USB driver to transmit data to the USB input/output server device.

The PC terminal may further include an application to perform data communication with the USB driver.

According to an aspect of the present disclosure, it may be possible to connect the PC terminal to the Ethernet/IP communication networks via USB ports without a separate Network Interface Card (NIC) so as to perform communication.

According to another aspect of the present disclosure, it may be possible to add the USB input/output server device to the Ethernet/IP switch to connect the plurality of Ethernet/IP communication networks so as to further connect the networks.

### BRIEF DESCRIPTION OF THE DRAWINGS

These and/or other aspects of the disclosure will become apparent and more readily appreciated from the following description of embodiments, taken in conjunction with the accompanying drawings of which:

FIG. 1 is a structural diagram of a network connection system according to an embodiment of the present disclosure;

FIG. 2 is a structural diagram of a network connection system according to another embodiment of the present disclosure;

FIG. 3 is a structural diagram of a network connection system according to another embodiment of the present disclosure;

FIG. 4 is a control block diagram of a network connection system according to an embodiment of the present disclosure;

FIG. 5 is a detailed block diagram of the network connection system according to the embodiment of the present disclosure; and

FIG. 6 is a flowchart illustrating a method of controlling a network connection system according to an embodiment of the present disclosure.

### DETAILED DESCRIPTION

Reference will now be made in detail to embodiments of the present disclosure, examples of which are illustrated in the accompanying drawings, wherein like reference numerals refer to like elements throughout.

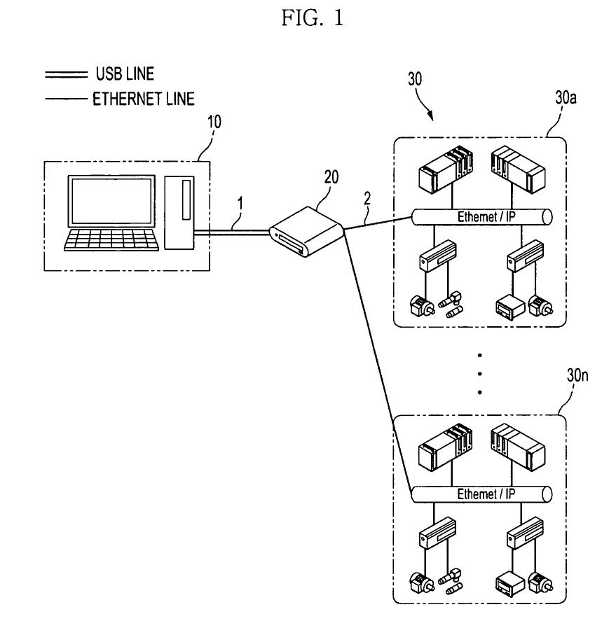

FIG. 1 is a structural diagram of a network connection system according to an embodiment of the present disclosure.

As shown in FIG. 1, the network connection system may include a Personal Computer (PC) terminal 10, a Universal Serial Bus (USB) input/output server device 20 to connect the PC terminal 10 to networks via USB ports, and one or more networks 30 including, as an example, network 30a to network 30n. The connection between the USB input/output server device 20 and the PC terminal 10 may be a wired or wireless connection. In addition, the connection between the USB input/output server device 20 and the one or more networks 30 may be a wired or wireless connection.

The PC terminal 10 may participate in the networks using different Ethernet/Internet protocol (IP) communication protocols by way of the connection between the USB ports (not shown) of the PC terminal 10 and the USB input/output service device 20. Conventionally, when the PC terminal 10 participates in the different networks 30, an Ethernet card is mounted in and connected to the PC terminal 10. In contrast, in the embodiment of the present disclosure, since the PC terminal 10 is directly connected to the USB input/output server device 20 including an Ethernet/IP driver using a USB line 1 so as to participate in the different networks 30, the PC terminal 10 may participate in the networks 30 without adding separate hardware to the PC.

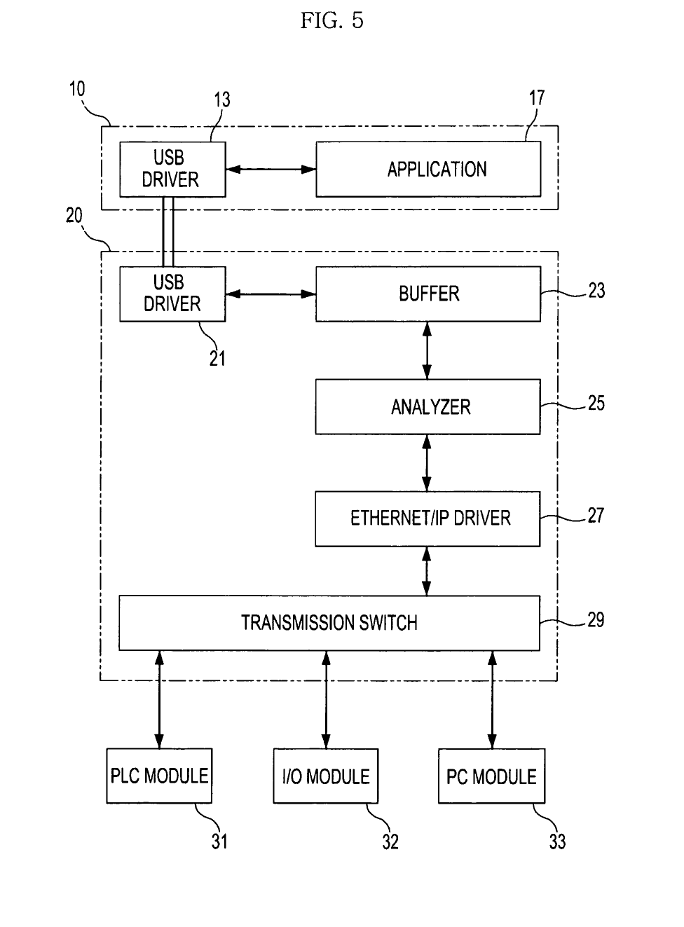

The USB input/output server device 20 includes the Ethernet/IP driver. The USB input/output server device 20 may be connected to the PC terminal 10 using the USB line 1 and may be connected to the different networks 30 using an Ethernet line 2. In addition, the USB input/output server device 20 includes a USB device driver communicating with the PC terminal 10 using the USB line, a buffer to store received data, an analyzer to convert the data stored in the buffer into data in a format readable by the Ethernet/IP driver, the Ethernet/IP driver to convert the received data into a format suitable for participation in Ethernet/IP communication, and a transmission switch to transmit the data to an external network. This will be described in detail with reference to FIG. 5. The USB input/output server device 20 may be embodied in a stand-alone package separate from the PC terminal 10 or alternatively may be embodied as a card or chip capable of being inserted into another device.

The plurality of networks 30 may be included and may be external networks or internal networks. In addition, the networks 30 are connected to the USB input/output server device 20 using the Ethernet line 2, and communicate with connection equipment using Ethernet/IP communication protocols.

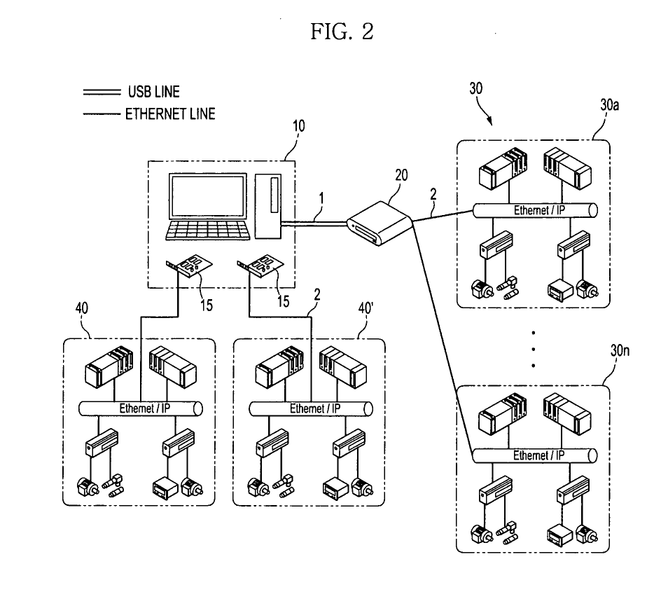

FIG. 2 is a structural diagram of a network connection system according to another embodiment of the present disclosure.

As shown in FIG. 2, the network connection system includes a PC terminal 10, a USB input/output server device 20 to connect the PC terminal 10 to networks using USB ports, Network Interface Cards (NICs) 15 for Ethernet/IP communication, which are internally mounted in the PC terminal 10, networks 30 including, as an example, network 30a to network 30n connected to the USB input/output server device 20, and networks 40 and 40′ directly connected to the PC terminal 10 via the NICs 15.

The configuration of FIG. 2 is different from that of FIG. 1 in that the PC terminal 10 is directly connected to the networks 40 and 40′. Conventionally, the NICs 15 are mounted in the PC terminal 10 in order to connect the PC terminal 10 to Ethernet/IP communication protocol type networks. In contrast, in the embodiment of the present disclosure, the USB input/output server device 20 connecting to the networks 30 is included in addition to the conventional network connection method. According to the current embodiment, in the case where the NICs 15 are mounted in the PC terminal 10 so as to participate in the plurality of networks, the number of networks in which the PC terminal may participate need not be limited to four.

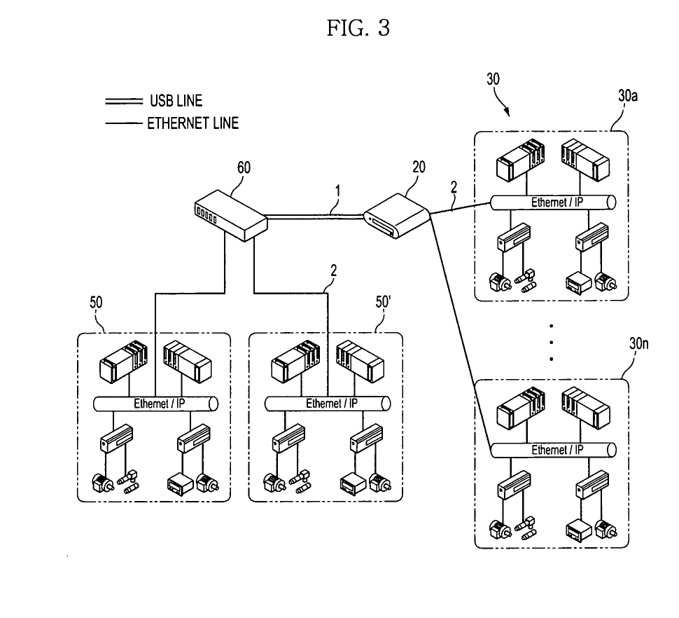

FIG. 3 is a structural diagram of a network connection system according to another embodiment of the present disclosure.

As shown in FIG. 3, the network connection system may include an Ethernet/IP switch 60 to connect networks to perform communication according to an Ethernet/IP communication protocol scheme, one or more networks such as 50 and 50′ connected to the Ethernet/IP switch 60, a USB input/output server device 20 connected to the Ethernet/IP switch 60 to further connect different networks 30, and one or more networks 30 including, as an example, network 30a to network 30n connected to the USB input/output server device 20.

The Ethernet/IP switch 60 connects networks to perform communication according to an Ethernet/IP protocol, the number of ports included in the Ethernet/IP switch 60 is 4, 8, 16, . . . , and an Ethernet/IP switch 60 supporting up to 16 ports is currently released. In the present embodiment, if the number of networks connected to the ports exceeds 16 (or 32, 64, . . . ), the USB input/output server device 20 may be added such that the different networks 30 are added without limitation.

Meanwhile, in the present embodiment, the Ethernet/IP switch 60 includes a USB port so as to be connected to the USB input/output server device 20 by a USB line.

In addition to the connection between the networks described in the present embodiment, a PC terminal 10 may also be connected to the USB input/output server device 20 or the Ethernet/IP switch 60 so as to be connected to the different networks.

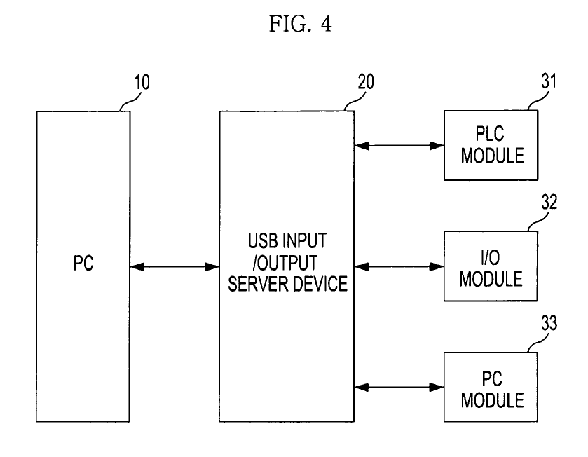

FIG. 4 is a control block diagram of a network connection system according to an embodiment of the present disclosure.

As shown in FIG. 4, the network connection system may include a PC terminal 10, a USB input/output server device 20 to connect the PC terminal 10 to networks 30 via USB ports, and a Programmable Logic Controller (PLC) module 31, an I/O module 32 and a PC module 33, which are connected on the networks.

The PC terminal 10 is connected to the USB input/output server device 20 via the USB port, and software to perform Ethernet/IP communication is installed therein. In addition, when the PC terminal 10 is connected to the USB input/output server device 20 via the USB port, automatic communication is realized and Ethernet/IP-associated tag data is simultaneously updated between the connected PC terminal 10 and USB input/output server device 20 (a shared data scheme). In addition, Ethernet/IP producer and consumer tags which are configured by the PC terminal 10 are automatically converted into Ethernet/IP communication protocol schemes such that the communication of the USB input/output server device 20 with the PLC module 31 or the I/O module 32 on the different networks is realized.

The USB input/output server device 20 is connected to the PC terminal 10 via the USB port, and performs a connection process so as to communicate with the different networks 30 based on the Ethernet/IP tag information received from the PC terminal 10. In addition, the USB input/output server device 20 transmits the producer tag data requested by the PLC module 31, the I/O module 32 or the PC module 33 on the different networks to a node or receives the consumer tag data requested by the PLC module 31, the I/O module 32 or the PC module 33 from the node.

FIG. 5 is a detailed block diagram of the network connection system according to the embodiment of the present disclosure.

As shown in FIG. 5, the network connection system may include a PC terminal 10 including a USB driver 13 and an application 17; a USB input/output server device 20 including a USB driver 21, a buffer 23, an analyzer 25, an Ethernet/IP driver 27, and a transmission switch 29; and a PLC module 31, an I/O module 32 and a PC module 33 connected to the USB input/output server device 20 on a network.

The USB driver 13 of the PC terminal 10 transmits/receives data necessary for communication between the modules to/from the USB driver 21 of the USB input/output server device 20 in real time according to a USB communication protocol. In addition, the USB driver 13 of the PC terminal 10 transmits/receives data to/from the application 17.

The application 17 of the PC terminal 10 stores communication data necessary for real-time communication.

The USB driver 21 of the USB input/output server device 20 transmits/receives real-time data to/from the USB driver 13 of the PC terminal 10, transmits the received data to the buffer 23, and prepares for the conversion of the data into data necessary for the Ethernet/IP communication.

The buffer 23 of the USB input/output server device 20 accumulates the data received from the USB driver 21, and prepares for the conversion of the data into the data necessary for the Ethernet/IP communication, as required.

The analyzer 25 of the USB input/output server device 20 analyzes and converts the data received from the buffer 23 to data readable by the Ethernet/IP driver 27 and transmits the analyzed data to the Ethernet/IP driver 27, such that the PC terminal 10 may perform the Ethernet/IP communication.

When the analyzable data is transmitted from the analyzer 25, the Ethernet/IP driver 27 of the USB input/output server device 20 analyzes and converts the data into data suitable for the Ethernet/IP communication protocol. That is, the format of the data transmitted from the PC is converted according to the Ethernet/IP communication protocol such that the PC terminal 10 communicates with the network to perform communication according to the Ethernet/IP communication protocol.

When the packets suitable for the Ethernet/IP communication protocol are transmitted from the Ethernet/IP driver 27, the transmission switch 29 of the USB input/output server device 20 is switched on such that the packets are transmitted to a target node, that is, the PLC module 31 or the I/O module 32. In addition, the transmission switch 29 finds the target node and transmits producer tag and consumer tag data requested by the PLC module 31 or the PC module 33 to the node.

Meanwhile, the above-described tag is the name of the Ethernet/IP communication object, the producer is a device connected to a node to produce Ethernet/IP communication information and transmit data to the consumer, the consumer is a device connected to a node to request data from the producer in order to consume the Ethernet/IP communication information, and the node is a physical contact of the Ethernet/IP.

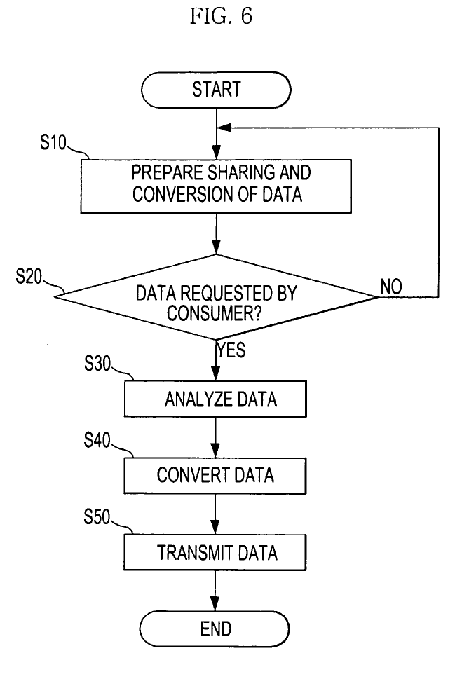

FIG. 6 is a flowchart illustrating a method of controlling a network connection system according to an embodiment of the present disclosure.

As shown in FIG. 6, when the PC terminal 10 is connected to the USB input/output server device 20 via the USB port, automatic communication may be realized, and Ethernet/IP-associated tag data is simultaneously updated between the connected PC terminal 10 and USB input/output server device 20 (a shared data scheme). The updated data is accumulated in the buffer 23 and, if necessary, is prepared for conversion into the data necessary for Ethernet/IP communication (S10).

Next, the Ethernet/IP driver 27 of the USB input/output server 20 checks whether or not data is requested by the consumer, that is, the I/O module 32 or the PLC module 31 (S20).

Next, when it determined that the consumer has requested the data, the data is analyzed. That is, the analyzer 25 of the USB input/output server device 20 analyzes and converts the data received from the buffer 23 to the data readable by the Ethernet/IP driver 27 and transmits the analyzed data to the Ethernet/IP driver 27 (S30).

Next, the data analyzed by the analyzer 25 is converted into data suitable for the Ethernet/IP communication protocol by the Ethernet/IP driver 27. That is, the data requested by the consumer on the network to perform the communication according to the Ethernet/IP communication protocol scheme is converted into data suitable for the Ethernet/IP communication protocol (S40).

Next, the transmission switch 29 transmits the data suitable for the Ethernet/IP communication protocol to the node to make a request for the data by switching (S50).

The method of controlling a network connection system according to the above-described embodiments may be recorded in computer-readable media or processor-readable media including program instructions to implement various operations embodied by a computer or processor. The media may also include, alone or in combination with the program instructions, data files, data structures, and the like.

Examples of computer-readable media or processor-readable media include: magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as code produced by a compiler, and files containing higher level code that may be executed by the computer using an interpreter.

The described hardware devices may also be configured to act as one or more software modules in order to perform the operations of the above-described embodiments, or vice versa. The method of controlling a network connection system may be executed on a general purpose computer or processor or may be executed on a particular machine such as the network connection system or USB input/output server device described herein.

Although a few embodiments of the present disclosure have been shown and described, it would be appreciated by those skilled in the art that changes may be made in these embodiments without departing from the principles and spirit of the disclosure, the scope of which is defined in the claims and their equivalents.

What is claimed is:

1. A network connection system comprising:
a Universal Serial Bus (USB) input/output server device connected to a plurality of Ethernet/IP communication networks; and
a Personal Computer (PC) terminal connected to a USB port of the USB input/output server device so as to be connected to the networks.

2. The network connection system according to claim 1, wherein the USB input/output server device includes a USB driver to receive data from the PC terminal.

3. The network connection system according to claim 2, wherein the USB driver receives data in real time according to a USB communication protocol.

4. The network connection system according to claim 2, wherein the USB input/output server device includes a buffer to prepare for conversion of the data into data necessary for Ethernet/IP communication.

5. The network connection system according to claim 4, wherein the USB input/output server device includes an analyzer to analyze the data prepared to be converted to data in a format necessary for the Ethernet/IP communication.

6. The network connection system according to claim 2, wherein the USB input/output server device includes an Ethernet/IP driver to convert the data into data suitable for an Ethernet/IP communication protocol.

7. The network connection system according to claim 1, wherein the USB input/output server device includes a transmission switch to transmit data to a consumer on the networks.

8. The network connection system according to claim 1, wherein the PC terminal includes a USB driver to transmit data to the USB input/output server device.

9. The network connection system according to claim 8, wherein the PC terminal further includes an application to perform data communication with the USB driver.

10. A network connection system comprising:
an Ethernet/Internet protocol (IP) switch connected to a plurality of Ethernet/IP communication networks; and
a universal serial bus (USB) input/output server device connected to the Ethernet/IP switch and further connected to one or more Ethernet/IP communication networks.

11. The network connection system according to claim 10, wherein the Ethernet/IP switch is connected to the plurality of networks by Ethernet lines.

12. The network connection system according to claim 10, wherein the USB input/output server device is connected to the Ethernet/IP switch by USB lines, and is further connected to different networks in addition to the networks connected to the Ethernet/IP switch.

13. The network connection system according to claim 10, wherein:
the USB input/output server device includes a USB port, and
the network connection system further includes a Personal Computer (PC) terminal connected to the USB port so as to be connected to the networks.

14. The network connection system according to claim 13, wherein the USB input/output server device includes a USB driver to receive data from the PC terminal.

15. The network connection system according to claim 14, wherein the USB driver receives data in real time by a USB communication protocol.

16. The network connection system according to claim 14, wherein the USB input/output server device includes a buffer to prepare for conversion of the data into data necessary for Ethernet/IP communication.

17. The network connection system according to claim 16, wherein the USB input/output server device includes an analyzer to analyze the data prepared to be converted to data in a format necessary for Ethernet/IP communication.

18. The network connection system according to claim 14, wherein the USB input/output server device includes an Ethernet/IP driver to convert the data into data suitable for an Ethernet/IP communication protocol.

19. The network connection system according to claim 13, wherein the PC terminal includes a USB driver to transmit data to the USB input/output server device.

20. The network connection system according to claim 19, wherein the PC terminal further includes an application to perform data communication with the USB driver.
